(19) United States
(12) Patent Application Publication
(10) Pub. No.: US 2014/0183167 A1
(43) Pub. Date: Jul. 3, 2014

(54) WELDING DEVICE FOR PANEL SHEETS AND WELDING METHOD FOR THE SAME

(71) Applicant: Hyundai Motor Company, Seoul (KR)

(72) Inventor: Sung Phil RYU, Seoul (KR)

(73) Assignee: Hyundai Motor Company, Seoul (KR)

(21) Appl. No.: 14/139,353

(22) Filed: Dec. 23, 2013

(30) Foreign Application Priority Data
Dec. 28, 2012 (KR) 10-2012-0157516
Nov. 22, 2013 (KR) 10-2013-0143270

(51) Int. Cl. B23K 28/02; B23K 10/02; B23K 11/11

(52) U.S. Cl. CPC B23K 28/02; B23K 11/11; B23K 10/022
USPC 219/86.9; 219/87; 219/121.46; 219/121.58

(57) ABSTRACT

A method of welding panels overlapping each other includes a one-directional clamping step that performs one-directional clamping by positioning electrodes of a pair of one-directional spot welding guns with respect to an upper panel and a lower panel overlapping each other, a pressure welding step that forms a plurality of pressure welding portions in a zero gap status by pressure-welding the upper panel to the lower panel in a temporary welding status, by pressing and supplying electricity to the upper panel with the electrodes of the one-directional spot welding guns, plasma spot step that forms a molten portion between the pressure welding portions by performing plasma welding on the pressure welding portions with a plasma welding machine, and a cooling step that forms a welded portion by overlapping the pressure welding portions and the molten portion between the upper panel and the lower panel by cooling the molten portion.

### CROSS-REFERENCE TO RELATED APPLICATION

The present application claims priority to Korean Patent Application No. 10-2012-0157516 and 10-2013-0143270 filed on Dec. 28, 2012, and Nov. 22, 2013, the entire contents of which is incorporated herein for all purposes by this reference.

### BACKGROUND OF THE INVENTION

1. Field of the Invention

The present invention relates to a welding device for panel sheets and a welding method for the same. More particularly, the present invention relates to a device and a method for welding panel sheets in one direction to a vehicle body panel making a closed cross-section.

2. Description of Related Art

In general, laser welding using a laser beam or electrical resistance welding using a spot welding machine is used to overlap and weld two steel sheets.

FIG. 1 is a process diagram of laser welding by a common laser welding system, in which a laser head 5 is disposed at the front end of an arm 3 of a robot 1 to weld a panel, using a laser beam LB.

The laser head 5 is connected with a laser vibrator 7 by an optical fiber and performs welding by radiating a laser beam LB while being moved along a welding pattern on a material 9 by the robot 1 controlled to operate by a robot controller C.

The laser welding is useful for overlap welding that welds a panel to a section making a closed cross-section in a vehicle body panel because one-directional welding is possible, but the thickness of the welded portion may not be uniform. This causes a drawback that welding is not easy at a position requiring dimensional precision of a welded portion such as a vehicle body and the welding strength depends on the molten status of the welded portion.

When the panel materials to be welded by the laser welding are galvanized steel sheets, as shown in FIG. 2, and when overlap welding is applied to the panels without a gap between the panel materials, a zinc plated layer may be evaporated at the welded portion. Pores may be generated by the zinc vapor or explosive pores may accompany.

As described above, since the laser welding or the spot welding of the related art that are used for overlap welding of panels have various drawbacks that back-and-forth welding is difficult, a welding method that can stably achieve overlap welding of panels in closed cross-sectional sections is required.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a device and a method for welding panels having advantages of being able to ensure rigidity at a welded portion by forming a molten portion at a temporary welding portion through plasma welding, with a gap controlled between the panels, temporarily welding the panels in a closed cross-sectional section of a vehicle body for overlap welding through one-directional spot welding.

In an aspect of the present invention, a method of welding panels overlapping each other, may include a one-directional clamping step that performs one-directional clamping by positioning electrodes of a pair of one-directional spot welding guns with respect to an upper panel and a lower panel overlapping each other, a pressure welding step that forms a plurality of pressure welding portions in a zero gap status by pressure-welding the upper panel to the lower panel in a temporary welding status, by pressing and supplying electricity to the upper panel with the electrodes of the one-directional spot welding guns, plasma spot step that forms a molten portion between the pressure welding portions by performing plasma welding on the pressure welding portions with a plasma welding machine, and a cooling step that forms a welded portion by overlapping the pressure welding portions and the molten portion between the upper panel and the lower panel by cooling the molten portion.

The pressure welding portions are larger in diameter of the molten portion.

The molten portion smaller in diameter than the pressure welding portions is formed at a center in the welded portion.

In another aspect of the present invention, a device for welding panels for welding overlapped panels, may include a fixing bracket configured to be fixed to an arm of a robot, a one-directional spot welding unit mounted on the fixing bracket to be movable forward or backward, and a plasma wlding unit fixed to the fixing bracket.

The one-directional spot welding unit may include a pair of first and second welding electrodes arranged in parallel at a predetermined distance from each other, perpendicular to forward or backward movement directions.

A first driving cylinder moving the first welding electrode forward or backward is mounted on the fixing bracket.

The first welding electrode is mounted on a first gun body and a first support rod is mounted on the first gun body, wherein a first support block through which the first support rod is slidably disposed is mounted on the fixing bracket.

The first driving cylinder is connected with the first gun body through a first actuating rod.

The second welding electrode is movable perpendicular to the forward or backward movement directions with respect to the fixing bracket.

A gap adjusting unit that moves the second welding electrode perpendicular to the forward or backward directions and adjusts a gap between the first and second welding electrodes is mounted on the fixing bracket.

The gap adjusting unit may include a servo motor, a movable body engaged to the servo motor and moved straight by a driving force received from the servo motor, and a guide module mounted on the fixing bracket, wherein the movable body is slidably mounted to the guide module such that the guide module guides the movable body moving straight along the guide module.

A second driving cylinder moving the second welding electrode forward or backward is mounted on the movable body.

The secodn welding electrode is mounted on a second gun body and a second support rod is mounted on the second gun body, wherein a second support block thorugh which the second support rod is slidably disposed is mounted on the movable body.

The second driving cylinder is connected with the second gun body through a second actuating rod.

The plasma welding unit may include a plasma torch mounted on the fixing bracket by a connecting bracket.

According to an exemplary embodiment of the present invention, rigidity at a welded portion can be ensured by forming and welding a molten portion at a temporary welding portion through plasma welding, with a gap controlled between the panels, temporarily welding the panels in a closed cross-sectional section of a vehicle body for overlap welding through one-directional spot welding.

Further, it is possible to improve welding strength by ensuring uniform quality of the welded portion by controlling a gap between panels and to ensure welding quality without an influence of zinc vapor even if a galvanized steel plate is used as a panel material.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a process diagram illustrating laser welding in a common laser welding system.

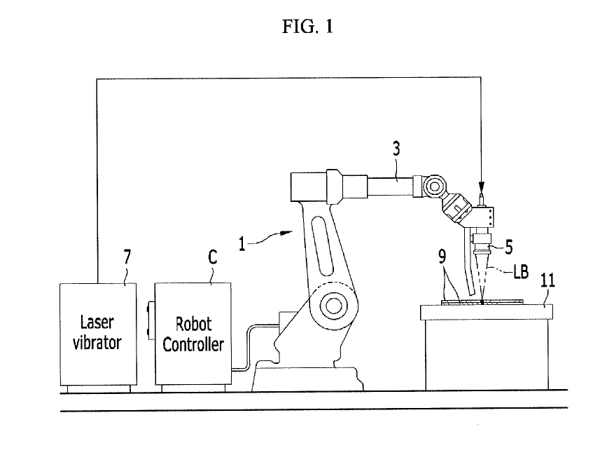

FIG. 2 is a view showing a laser welding status of a common galvanized steel sheet.

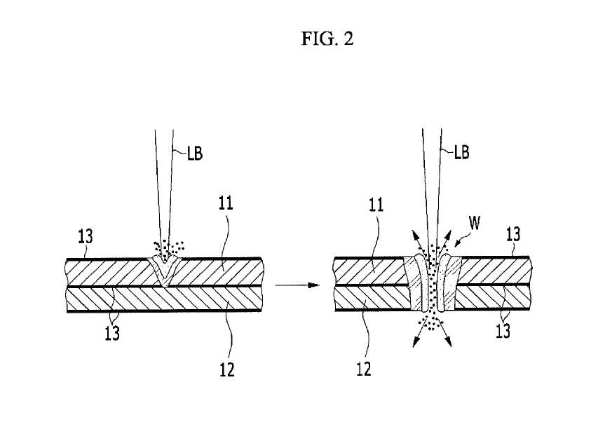

FIG. 3 is a perspective view showing a device for welding panels according to an exemplary embodiment of the present invention.

FIG. 4 is a front view showing the configuration of the device for welding panels according to an exemplary embodiment of the present invention.

FIG. 5 is a flowchart illustrating a method of welding panels according to an exemplary embodiment of the present invention.

FIG. 6 is a process diagram illustrating the method of welding panels according to an exemplary embodiment of the present invention.

FIG. 7 is a diagram schematically showing a vehicle body welded by a device for welding panels according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Exemplary embodiments of the present invention will be described hereinafter in detail with reference to the accompanying drawings.

The sizes and thicknesses of the configurations shown in the drawings are provided selectively for the convenience of description, such that the present invention is not limited to those shown in the drawings and the thicknesses are exaggerated to make some parts and regions clear.

However, parts that are not related to the description are not drawn to make exemplary embodiments of the present invention clear.

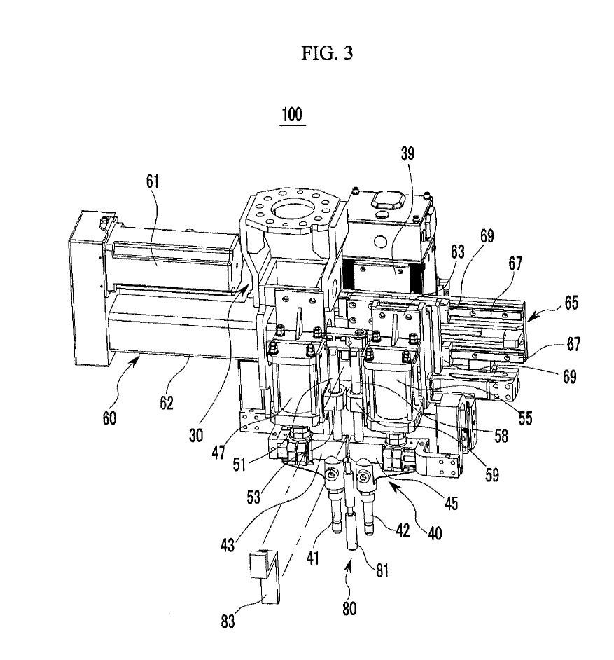

FIG. 3 is a perspective view showing a device for welding panels according to an exemplary embodiment of the present invention.

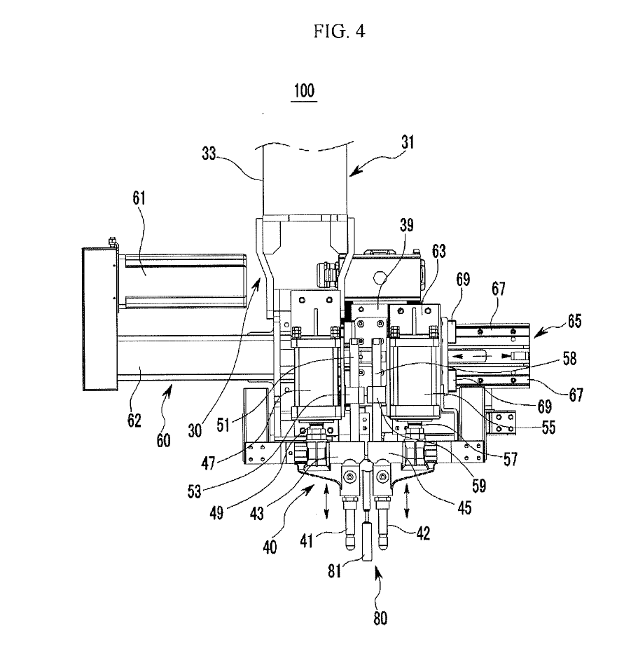

FIG. 4 is a front view showing the configuration of the device for welding panels according to an exemplary embodiment of the present invention.

Referring to FIGS. 3 and 4, a device 100 for welding panels according to an exemplary embodiment of the present invention may be used in a vehicle body part assembly process that welds parts for assembling a vehicle body, such as vehicle body panels.

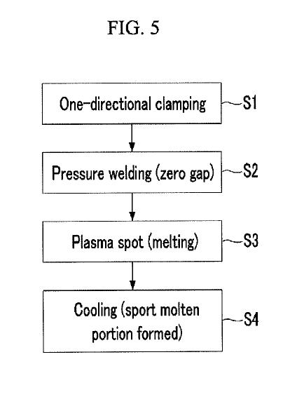

For example, a vehicle body panel may include an upper panel 10 (hereafter, see FIG. 5) and a lower panel (hereafter, see FIG. 5) which overlap each other, and the upper panel 10 and the lower panel 20 may include panels materials such as a steel sheet and a galvanized steel sheet.

The device 100 for welding panels according to an exemplary embodiment of the present invention controls a gap between the upper and lower panels 10 and 20 by temporarily welding the panels 10 and 20 in a closed cross-sectional section of a vehicle body panel for overlap welding through one-directional spot welding. Thereafter, the device 100 for welding panels according to an exemplary embodiment of the present invention can ensure rigidity at a welded portion of a vehicle body panel by forming a molten portion at a temporary welding portion through plasma welding and by welding the panels. Further, the device 100 for welding panels according to an exemplary embodiment of the present invention can ensure the quality of welding without an influence from zinc fumes, even if a galvanized steel sheet is used for the materials of the panels 10 and 20.

The device 100 for welding panels according to an exemplary embodiment of the present invention basically includes a fixing bracket 30, a one-directional spot welding unit 40, and a plasma welding unit 80.

The fixing bracket 30 can be detachably mounted on an arm 33 of a robot and various parts to be described below can be mounted on the fixing bracket 30.

The one-directional spot welding unit 40 can enter a closed cross-sectional section of a panel in one direction and perform spot welding on the closed cross-sectional section of the panel, when two electrodes cannot enter in both directions of a panel, such as a panel with a closed section.

The one-directional spot welding unit 40 can weld a closed cross-sectional section of a panel, using welding heat by electric resistance, by supplying a current simultaneously with pressing the surface of the panel with a welding electrode, which is described in detail.

In an exemplary embodiment of the present invention, the one-directional spot welding unit 40 can control a gap between panels by temporarily welding the panels in a closed cross-sectional section of a vehicle body panel for overlap welding through one-directional spot welding.

The one-directional spot welding unit 40 can form a plurality of pressure welding portions in a zero gap status, by pressure-welding the upper panel 10 to the lower panel 20 in a temporary welding state by supplying a current to the upper panel 10 under pressure.

Further, the one-directional spot welding unit 40 clamps the upper panel 10 and the lower panel 20, which overlap each other, for a vehicle body panel in one direction.

The one-directional spot welding unit 40 includes a pair of first and second welding electrodes 41 and 42 that is arranged in parallel at a predetermined distance from each other and moves forward and backward (in the directions of arrows in FIG. 4) with respect to the overlapping upper panel 10 and lower panel 20.

The first and second welding electrodes 41 and 42 may be a positive (+) welding electrode and a negative (−) welding electrode, respectively, for one-directional spot welding of the closed cross-sectional section of the overlapping upper panel 10 and lower panel 20.

A current supply unit 39 for converting power into a welding current and supplying the welding current to the first and second welding electrodes 41 and 42 is mounted on the fixing bracket 30. The current supply unit 39 is a device supplying a current for welding which is known in the art, so the detailed description is not provided herein.

The first welding electrode 41 is mounted on a first gun body 43 in a tip type and the second welding electrode 42 is mounted on a second gun body 45 in a tip type.

The fixing bracket 30 is equipped with a first driving cylinder 47 that moves the first welding electrode 41 forward and backward.

The first driving cylinder 47, a common pneumatic or hydraulic actuating cylinder, includes a first actuating rod 49 moving forward/backward. The first actuating rod 49 is connected with the first gun body 43.

A first support rod 51 is disposed on the first gun body 43 and a first support block 53 through which the support rod 51 is disposed is mounted on the fixing bracket 30.

The first support rod 51 guides the first gun body 43 moving forward/backward while supported by the first support block 53, when the first gun body 43 is moved forward/backward by the first driving cylinder 47.

In an exemplary embodiment of the present invention, the second welding electrode 42 can reciprocate (left and right in the figure) perpendicular to the forward/backward movement directions of the welding electrodes 41 and 42. The structure that moves the second welding electrode 42 is described in detail below.

A gap adjusting unit 60 that moves the second welding electrode 42 perpendicular to the forward/backward movement directions and adjusts the gap (pitch) between the first and second welding electrodes 41 and 42 is mounted on the fixing bracket 30.

The gap adjusting unit 60 includes a servo motor 61, a movable body 63 moved straight to the left and right by a driving force from the servo motor 61, and a guide module 65 guiding the movable body 63 moving straight.

The servo motor 61 is combined with a power converter 62 that converts the rotation of the servo motor 61 into a straight motion and the movable body 63 can slide on the guide module 65.

The power converter 62 converts the rotation of the servo motor 61 into a straight motion and the movable body 63 is slid on the guide module 65 by the servo motor 61. The configuration of the power converter is well known in the art and the detailed description is not provided herein.

The guide module 65, which guides the movable body 63 moving straight, is also called an LM guide in the art. The guide module 65 may include guide rails 67 on the fixing bracket 30 and sliders 69 connected with the movable body 63 and slidably coupled to the guide rails 67.

As the servo motor 62 is operated, the power converter 62 converts the rotation of the servo motor 62 into a straight motion of the movable body 63, so the movable body 63 slides on the guide module 65.

The movable body 63 has a second welding electrode 42 and is equipped with a second driving cylinder 55 that moves the second welding electrode 42 upward/downward.

The second driving cylinder 55, a common pneumatic or hydraulic actuating cylinder, includes a second actuating rod 57 moving forward/backward. The second actuating rod 57 is connected with the second gun body 45.

A second support rod 58 is disposed on the second gun body 45 and a second support block 59 through which the second support rod 58 is disposed is mounted on the movable body 63.

The second support rod 58 guides the second gun body 45 moving forward/backward while supported by the second support block 59, when the second gun body 45 is moved forward/backward by the second driving cylinder 55.

The plasma welding unit 80, which welds a vehicle body panel, using heat by plasma arc, temporarily welds the lower panel 20 and the upper panel 10 and then forms a molten portion at the pressure molding portion by ejecting plasma arc at a high speed to the vehicle body panel from above.

The plasma welding unit 80 includes a plasma torch 81 disposed on the fixing bracket 30 between the first and second welding electrodes 41 and 42 of the one-directional spot welding unit 40.

The plasma torch 81 includes a tungsten electrode (+electrode) and an orifice body that is a nozzle electrode (−electrode). When arc is generated between the tungsten electrode and the nozzle electrode and a compressed gas is supplied, the plasma torch 81 can form a molten portion at the pressure welding portion by generating plasma arc accompanied by ultra high-temperature and high-density energy and ejecting the plasma arc through the orifice of the nozzle electrode.

The plasma torch 81 is disposed between the first and second welding electrodes 41 and 42 of the one-directional spot welding unit 40 and may be mounted on the fixing bracket 30 by a connecting bracket 83.

The plasma torch 81 is a plasma torch for a welding machine which is well known in the art, so the detailed description is not provided herein.

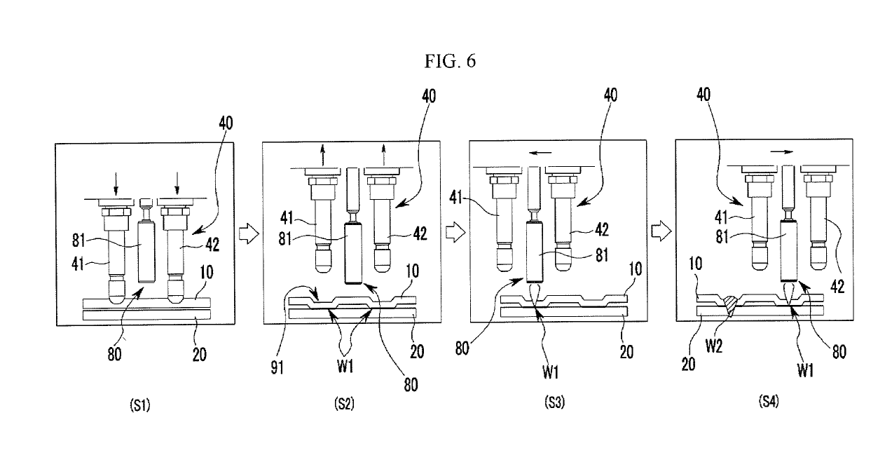

FIG. 5 is a flowchart illustrating a method of welding panels according to an exemplary embodiment of the present invention and FIG. 6 is a process diagram illustrating the method of welding panels according to an exemplary embodiment of the present invention.

Referring to FIGS. 5 and 6, a method of welding panels according to an exemplary embodiment of the present invention is a method of welding panels overlapping each other, particularly, which makes it possible to ensure rigidity at a welded portion by forming a molten portion at a temporary welding portion through plasma welding, with a gap controlled between the panels, temporarily welding the panels in a closed cross-sectional section of a vehicle body panel for overlap welding through one-directional spot welding.

The method of welding panels, first, performs a one-directional clamping step Si that positions the first and second electrodes 41 and 42 of the one-directional spot welding unit 40 with respect to the overlapping upper panel 10 and lower panel 20 and then clamps the panels 10 and 20 in one direction.

With the device 100 for welding panels according to an exemplary embodiment of the present invention moved to the welding portion of the overlapping upper panel 10 and lower panel 20, the first and second welding electrodes 41 and 42 are positioned to the welding portion of the upper panel 10 and the lower panel 20 by operating the first and second driving cylinders 47 and 55.

Thereafter, the welding portion of the upper panel 10 and the lower panel 20 is pressed while the first and second welding electrodes 41 and 42 are moved forward by the first and second driving cylinders 47 and 55, and the panels 10 and 20 are clamped in one direction.

The first gun body 43 with the first welding electrode 41 is guided downward by the first support rod 51 in the first support block 53. Further, the second gun body 45 is guided downward by the second support rod 58 in the second support block 59.

Next, the method performs a pressure welding step Si that forms a plurality of pressure welding portions W1 in a zero gap status by pressure-welding the upper panel 10 to the lower panel 20 in a temporary welding status, by pressing and supplying electricity to the upper panel 10 with the first and second welding electrodes 41 and 42.

Grooves 3 that are pressure marks may be formed at the pressure welding portions W1 by the first and second welding electrodes 41 and 42 pressing the upper panel 10.

Next, in an exemplary embodiment of the present invention, the first and second welding electrodes 41 and 42 are moved upward by the first and second driving cylinders 47 and 55.

The first gun body 43 with the first welding electrode 41 is guided upward by the first support rod 51 in the first support block 53 and the second gun body 45 with the second welding electrode 42 is guided upward by the second support rod 58 in the second support block 59.

Thereafter, the plasma torch 81 of the plasma welding unit 80 is moved to the pressure welding portion W1 formed by the first welding electrode 41.

A plasma spot step S3 that forms a molten portion W2 between the pressure welding portions W1 by performing plasma welding on the pressure welding portions W1 with a plasma welding machine is performed.

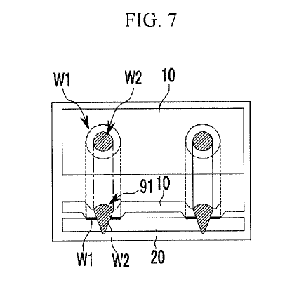

Accordingly, in an exemplary embodiment of the present invention, the pressure welding portion W1 is plasma-welded by the plasma torch 81, such that a molten portion W2 can be formed at the pressure welding portion W1, as in FIG. 7.

Next, a cooling step S4 that forms a welded portion by overlapping the pressure welding portions W1 and the molten portion W2 between the upper panel 10 and the lower panel 20 by cooling the molten portion W2 is performed.

The pressure welding portions W1 may be larger in diameter than the molten portion W2 and the molten portion W2 smaller in diameter than the pressure welding portions W1 may be formed at the center in the welded portion.

Accordingly, one-directional overlap welding is possible for galvanized steel plates, steel panels, or common panels by the method of welding panels described above. In particular, the molten portion W2 is formed and welded to the pressure welding portions W1 temporarily welded by plasma welding with a gap controlled between the panels by temporarily welding panels in a closed cross-sectional area of a vehicle body panel for overlap welding through one-directional spot welding, such that rigidity of the welded portion can be ensured.

Further, it is possible to improve welding strength by ensuring uniform quality of the welded portion by controlling a gap between panels and to ensure welding quality without an influence of zinc vapor even if a galvanized steel plate is used as a panel material.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents.

What is claimed is:

1. A method of welding panels overlapping each other, the method comprising:
a one-directional clamping step that performs one-directional clamping by positioning electrodes of a pair of one-directional spot welding guns with respect to an upper panel and a lower panel overlapping each other;
a pressure welding step that forms a plurality of pressure welding portions in a zero gap status by pressure-welding the upper panel to the lower panel in a temporary welding status, by pressing and supplying electricity to the upper panel with the electrodes of the one-directional spot welding guns;
plasma spot step that forms a molten portion between the pressure welding portions by performing plasma welding on the pressure welding portions with a plasma welding machine; and
a cooling step that forms a welded portion by overlapping the pressure welding portions and the molten portion between the upper panel and the lower panel by cooling the molten portion.

2. The method of claim 1, wherein the pressure welding portions are larger in diameter of the molten portion.

3. The method of claim 1, wherein the molten portion smaller in diameter than the pressure welding portions is formed at a center in the welded portion.

4. A device for welding panels for welding overlapped panels, comprising:
a fixing bracket configured to be fixed to an arm of a robot;
a one-directional spot welding unit mounted on the fixing bracket to be movable forward or backward; and
a plasma wlding unit fixed to the fixing bracket.

5. The device of claim 4, wherein the one-directional spot welding unit includes a pair of first and second welding electrodes arranged in parallel at a predetermined distance from each other, perpendicular to forward or backward movement directions.

6. The device of claim 5, wherein a first driving cylinder moving the first welding electrode forward or backward is mounted on the fixing bracket.

7. The device of claim 6,
wherein the first welding electrode is mounted on a first gun body and a first support rod is mounted on the first gun body, and
wherein a first support block through which the first support rod is slidably disposed is mounted on the fixing bracket.

8. The device of claim 7, wherein the first driving cylinder is connected with the first gun body through a first actuating rod.

9. The device of claim 5, wherein the second welding electrode is movable perpendicular to the forward or backward movement directions with respect to the fixing bracket.

10. The device of claim 9, wherein a gap adjusting unit that moves the second welding electrode perpendicular to the forward or backward directions and adjusts a gap between the first and second welding electrodes is mounted on the fixing bracket.

11. The device of claim 10, wherein the gap adjusting unit includes:
a servo motor;
a movable body engaged to the servo motor and moved straight by a driving force received from the servo motor; and
a guide module mounted on the fixing bracket, wherein the movable body is slidably mounted to the guide module such that the guide module guides the movable body moving straight along the guide module.

12. The device of claim 11, wherein a second driving cylinder moving the second welding electrode forward or backward is mounted on the movable body.

13. The device of claim 12,
wherein the secodn welding electrode is mounted on a second gun body and a second support rod is mounted on the second gun body, and
wherein a second support block thorugh which the second support rod is slidably disposed is mounted on the movable body.

14. The device of claim 13, wherein the second driving cylinder is connected with the second gun body through a second actuating rod.

15. The device of claim 4, wherein the plasma welding unit includes a plasma torch mounted on the fixing bracket by a connecting bracket.
